(19) United States
(12) Patent Application Publication
(10) Pub. No.: US 2025/0388477 A1
(43) Pub. Date: Dec. 25, 2025

(54) PRODUCTION METHOD FOR A SOLID PARTICLE

(71) Applicant: KAO CORPORATION, Tokyo (JP)

(72) Inventors: Saki HAMADA, Chuo-ku (JP); Hayato MIYAZAKI, Chuo-ku (JP)

(73) Assignee: KAO CORPORATION, Tokyo (JP)

(21) Appl. No.: 18/751,554

(22) Filed: Jun. 24, 2024

(51) Int. Cl. C01B 33/12

(52) U.S. Cl. CPC C01B 33/12; C01P 2004/32; C01P 2004/60

(57) ABSTRACT

Provided is a production method for a solid particle, including: heating a raw material composition containing an oily component to impart fluidity to the raw material composition; granulating the raw material composition having imparted thereto the fluidity to form a granular raw material; and dropping the granular raw material into powder to coat a surface of the granular raw material with the powder, wherein a temperature of the raw material composition at the time of ejection in formation of the granular raw material is equal to or more than a melting point of the raw material composition and is equal to or less than a temperature higher by 17° C. than the melting point.

### TECHNICAL FIELD

The present invention relates to a production method for a solid particle.

### BACKGROUND ART

Solid particles that have heretofore been known such as solid cosmetics have been generally in such a form that powder is subjected to compression molding to be stored in a shallow-bottom tray like a foundation or in such a form that a composition that is a solid at room temperature is molded into a predetermined shape like a lipstick. In addition to the solid cosmetics in such forms, a solid cosmetic in a granular form (granular solid cosmetic) has been proposed in recent years.

In, for example, Japanese Patent Application Laid-open No. 2021-109850 (Patent Literature 1), there is a description of a production method for a granular solid cosmetic including granulating a raw material for a cosmetic and causing powder to adhere to the surface of the granulated raw material for a cosmetic.

### SUMMARY OF THE INVENTION

The present invention relates to a production method for a solid particle including: heating a raw material composition containing an oily component to impart fluidity to the raw material composition: granulating the raw material composition having imparted thereto the fluidity to form a granular raw material; and dropping the granular raw material into powder to coat a surface of the granular raw material with the powder,
wherein (i) a temperature of the raw material composition at a time of ejection in formation of the granular raw material is equal to or more than a melting point of the raw material composition and is equal to or less than a temperature higher by 17° C. than the melting point: or
wherein (ii) an exposure ratio of the granular raw material when being dropped into the powder is one of 5% or less or 10% or more.

When the inventors of the present invention have produced the granular solid cosmetic described in Patent Literature 1, it has been found that some of granular particles after production may have dents.

The present invention relates to a production method for a solid particle having the occurrence of a dent suppressed.

The inventors of the present invention have found that, when a granular raw material formed by granulating a raw material composition containing an oily component having imparted thereto fluidity by heating is dropped into powder to coat the surface of the granular raw material with the powder, a solid particle having the occurrence of a dent suppressed is obtained in a high yield by (i) setting the difference between the temperature at which the raw material composition is granulated and the melting point of the raw material composition within a specific range or (ii) setting the exposure ratio from the powder of the granular raw material dropped into the powder within a specific range.

The present invention relates to the following items [1] and [2].
[1] A production method for a solid particle, including: heating a raw material composition containing an oily component to impart fluidity to the raw material composition; granulating the raw material composition having imparted thereto the fluidity to form a granular raw material; and dropping the granular raw material into powder to coat a surface of the granular raw material with the powder, wherein a temperature of the raw material composition at a time of ejection in formation of the granular raw material is equal to or more than a melting point of the raw material composition and is equal to or less than a temperature higher by 17° C. than the melting point.
[2] A production method for a solid particle, including: heating a raw material composition containing an oily component to impart fluidity to the raw material composition; granulating the raw material composition having imparted thereto the fluidity to form a granular raw material; and dropping the granular raw material into powder to coat a surface of the granular raw material with the powder, wherein an exposure ratio of the granular raw material when being dropped into the powder is one of 5% or less or 10% or more.

### BRIEF DESCRIPTION OF DRAWINGS

FIG. 1 is a schematic view for illustrating a production method according to at least one embodiment of the present invention.

FIG. 2 is a schematic view for illustrating the production method including using a vibration feeder according to at least one embodiment of the present invention.

FIG. 3 is a view for illustrating solid particles having no dents on surfaces.

FIG. 4 is a view for illustrating solid particles having dents on surfaces.

### DETAILED DESCRIPTION OF THE INVENTION

The present invention is described below on the basis of its exemplary embodiments with reference to the drawings. The present invention relates to a production method for a solid particle.

### [Production Method for Solid Particle]

A first aspect of a production method for a solid particle according to at least one embodiment of the present invention includes: heating a raw material composition containing an oily component to impart fluidity to the raw material composition: granulating the raw material composition having imparted thereto the fluidity to form a granular raw material; and dropping the granular raw material into powder to coat a surface of the granular raw material with the powder. A temperature of the raw material composition at the time of ejection in formation of the granular raw material is equal to or more than a melting point of the raw material composition and is equal to or less than a temperature higher by 17° C. than the melting point.

Further, a second aspect of a production method for a solid particle according to at least one embodiment of the present invention includes: heating a raw material composition containing an oily component to impart fluidity to the raw material composition: granulating the raw material composition having imparted thereto the fluidity to form a granular raw material; and dropping the granular raw material into powder to coat a surface of the granular raw material with the powder. An exposure ratio of the granular raw material when being dropped into the powder is one of 5% or less or 10% or more.

As used herein, the term “raw material” in each of the terms “raw material composition” and “granular raw material” means a raw material for a solid particle that is a product, and does not limit a material or the like.

The production method for a solid particle according to at least one embodiment of the present invention exhibits such and effect that a solid particle having the occurrence of a dent suppressed is obtained in a high yield. The reason why the production method exhibits such effect is not clear but is conceived as described below.

The “dent” in the solid particle according to at least one embodiment of the present invention refers to such a portion recessed from the surrounding in the solid particle as described below: the most recessed point of the recessed portion is present on an inner side of the solid particle from an imaginary plane including the peripheral edge of the recessed portion.

Not all, but some of solid particles each obtained by forming a raw material composition containing an oily component, the composition having imparted thereto fluidity by heating, into a granular shape, followed by cooling, may include dents.

The inventors of the present invention have made various investigations, and as a result, have conceived the following. In the case where a raw material composition is granulated to form a granular raw material, when the temperature at which the raw material composition is granulated is too high as compared to the melting point of the raw material composition, for example, the raw material composition is deformed owing to impact when being dropped into powder because of high fluidity, and the volume contraction occurs as a result of rapid cooling. Thus, dents occur in a large number of solid particles after cooling. In view of the foregoing, the inventors of the present invention have made investigations, and as a result, have found that, when the temperature at which the raw material composition is granulated is equal to or more than the melting point of the raw material composition and is equal to or less than a temperature higher by 17° C. than the melting point, a solid particle having the occurrence of a dent suppressed is obtained in a high yield. It is conceived that, when the temperature of the raw material composition in formation of a granular raw material falls within the above-mentioned range, the influence of a change in volume of the raw material composition caused by impact from dropping and cooling is reduced, and hence the occurrence of a dent caused by the contraction of the raw material composition is suppressed.

In addition, the inventors of the present invention have also found that, when the granular raw material formed by granulating the raw material composition having imparted thereto the fluidity by heating is dropped into the powder, a dent occurs in an exposed portion of the granular raw material that is not brought into contact with the powder. It has been conceived that the foregoing occurs owing to the difference in contraction speed caused by the difference in cooling speed of the granular raw material between the portion of the granular raw material that is not brought into contact with the powder and the portion of the granular raw material that is brought into contact with the powder. That is, first, the surface portion of the granular raw material that is brought into contact with the powder is rapidly cooled to be solidified, but the portion that is not brought into contact with the powder and the center portion are cooled more slowly to remain soft accordingly. Then, it is conceived that, when the center portion is gradually cooled and solidified to be contracted, the exposed surface portion is also drawn into the center portion to be solidified, and thus a dent occurs in a solid particle to be obtained. In addition, it has been found that, only when the exposure ratio at the time of dropping of the granular raw material into the powder falls within a specific range, a dent occurs.

In view of the foregoing, the inventors of the present invention have made investigations, and have found that, when the granular raw material is dropped into the powder, the occurrence of a dent is suppressed by substantially burying the granular raw material in the powder to set the exposure ratio to 5% or less, or by setting the exposure ratio from the powder of the granular raw material to 10% or more. It is conceived that those conditions reduced the influence of the difference in contraction caused by cooling of the granular raw material, and the occurrence of a dent of a solid particle to be obtained is suppressed.

### First Aspect

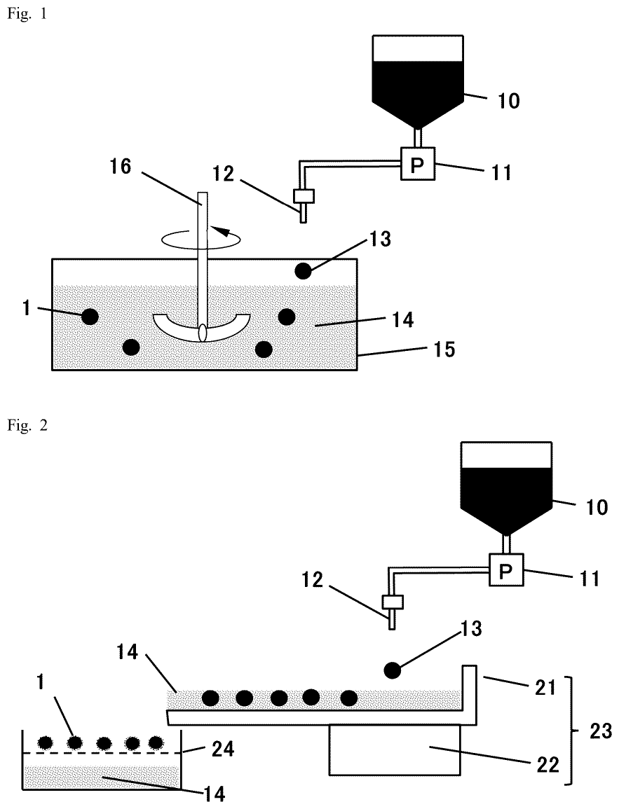

An example of the first aspect of the production method for a solid particle according to at least one embodiment of the present invention is described below with reference to FIG. 1.

In the production method according to at least one embodiment of the present invention, the expression “coat the surface of a granular raw material 13 with powder 14” means not only that the entirety of the surface of the granular raw material 13 is coated with the powder 14 but also that at least part of the surface of the granular raw material 13 is coated with the powder 14. From the viewpoint of improving the adhesion resistance and transportation resistance of the solid particle, the entirety of the surface of the granular raw material 13 is preferably coated with the powder 14.

### [Impartment of Fluidity to Raw Material Composition]

The impartment of fluidity to the raw material composition is performed by heating the raw material composition containing the oily component. A raw material composition 10 having imparted thereto the fluidity may be obtained by heating the raw material composition to a temperature equal to or more than the melting point of at least one substance in the raw material composition. In addition, it is preferred that the raw material composition be heated to a temperature, which is equal to or more than the melting point thereof and is equal to or less than a temperature higher by 25° C. than the melting point, from the viewpoint of suppressing the occurrence of a dent in a solid particle 1.

### [Formation of Granular Raw Material]

In the formation of the granular raw material, the raw material composition 10 having imparted thereto the fluidity is granulated through its ejection to form the granular raw material 13. When the raw material composition 10 having imparted thereto the fluidity illustrated in FIG. 1 is a liquid obtained by heating the raw material composition to its melting point or more, the ejection of the raw material composition 10 delivered with a pump 11 from the tip of a nozzle 12 can form the granular raw material 13 as a droplet. The raw material composition 10 may be cooled to a temperature, which is equal to or more than the melting point thereof and is equal to or less than a temperature at the time of ejection, between the pump 11 and the nozzle 12. The temperature of the raw material composition 10 at the time of ejection can be precisely adjusted by cooling.

An apparatus for forming the granular raw material 13 from the raw material composition 10 having imparted thereto the fluidity through ejection of the composition is not limited to an apparatus illustrated in FIG. 1, and a known droplet-producing apparatus or the like may be used.

The granulation method is not limited to the case of ejection and dropping from the nozzle 12 as illustrated in FIG. 1, and can also be performed by methods involving, for example, changing the ejection direction from the nozzle, and cutting the flowed raw material composition 10 with a shutter or the like.

In the formation of the granular raw material, the temperature of the raw material composition 10 at the time of ejection is equal to or more than the melting point thereof and is equal to or less than a temperature higher by 17° C. than the melting point. The temperature of the raw material composition 10 is equal to or more than preferably a temperature higher by 0.5° C. than the melting point, more preferably a temperature higher by 1.0° C. than the melting point, still more preferably a temperature higher by 2.0° C. than the melting point from the viewpoint of retarding the solidification of the granular raw material 13 to accelerate the adhesion of the powder 14, and the temperature is equal to or less than preferably a temperature higher by 15° C. than the melting point, more preferably a temperature higher by 10° C. than the melting point, still more preferably a temperature higher by 8.0° C. than the melting point, yet still more preferably a temperature higher by 6.0° C. than the melting point from the viewpoint of further suppressing the occurrence of a dent in the solid particle 1.

The temperature of the raw material composition 10 at the time of ejection can be adjusted by controlling the heating temperature of the raw material composition 10, the flow rate at the time of ejection of the raw material composition 10, and the like. For example, in the aspect illustrated in FIG. 1, the temperature of the raw material composition 10 can be adjusted by appropriately changing the temperature control of the nozzle 12. The temperature adjustment may be performed by heating or cooling the raw material composition 10. It is preferred that the temperature adjustment be performed by heating the raw material composition 10 to the temperature at the time of ejection and further controlling also the temperature of the nozzle 12 from the viewpoint of precisely adjusting the temperature of the raw material composition 10 at the time of ejection. The temperature of the raw material composition 10 at the time of ejection may be measured by any method, but it is preferred that the temperature measurement be performed, for example, by directly measuring the temperature of the tip of the nozzle 12 with a thermocouple, an infrared camera, or the like.

The temperature of the raw material composition 10 may be measured by a method described in Examples.

The solid particle 1 that is the object of the production method according to at least one embodiment of the present invention includes a core portion and a shell portion formed of the layer of the raw material composition that has incorporated therein the powder for coating the core portion, and hence the size thereof is substantially the same as or slightly larger than that of the granular raw material 13 formed as a droplet by being ejected from the tip of the nozzle 12. That is, the granular raw material 13 is preferably adjusted based on the average projected area, diameter, and/or weight of the solid particle 1 to be obtained when being placed on a plane.

The particle diameter of the granular raw material 13 mainly correlates with the outer diameter of the nozzle. When the outer diameter of the nozzle is increased, the particle diameter of the granular raw material 13 is increased. To this end, for example, when the granular raw material 13 is formed as a droplet by ejecting the raw material composition 10 that is a liquid from the tip of the nozzle 12, the outer diameter of the nozzle 12 may be changed in accordance with the particle diameter of the target solid particle. The outer diameter of the nozzle 12 is preferably 0.5 mm or more, more preferably 1 mm or more, still more preferably 1.5 mm or more from the viewpoint of obtaining a particle diameter corresponding to the usage amount of the solid particle 1 per time. In addition, the outer diameter is preferably 20 mm or less, more preferably 10 mm or less, still more preferably 5 mm or less from the viewpoint of stably dropping the granular raw material 13. In particular, the outer diameter of the nozzle 12 is preferably 0.5 mm or more and 20 mm or less, more preferably 1 mm or more and 10 mm or less, still more preferably 1.5 mm or more and 5 mm or less.

[Coating of Surface of Granular Raw Material with Powder]

In the coating of the surface of the granular raw material with the powder, the granular raw material 13 is dropped into the powder 14 to coat the surface of the granular raw material 13 with the powder 14, to thereby provide the solid particle 1. The powder 14 may be stored in a container 15. In addition, when such an apparatus as illustrated in FIG. 2 to be described later is used, the powder 14, which falls to a sieve 24 through the operation of a vibration feeder 23, may be continuously supplied with a powder-supplying device in accordance with the falling speed so that the amount of the powder 14 on a trough 21 is constant.

The distance at which the granular raw material 13 is dropped, that is, the distance between the tip of the nozzle 12 and the outermost surface of the layer of the powder 14 is more than 0 mm. That is, it is appropriate that the powder 14 and the nozzle 12 be out of contact with each other. However, the distance is preferably 2 mm or more, more preferably 3 mm or more, still more preferably 4 mm or more from the viewpoint of forming the granular raw material 13 into a spherical shape, and is preferably 100 mm or less, more preferably 50 mm or less, still more preferably 20 mm or less from the viewpoints of: alleviating the impact at the time of contact between the granular raw material 13 that has been dropped and the powder 14 to prevent the deformation of the granular raw material 13; and suppressing the cooling of the granular raw material 13 at the time of dropping.

The thickness of the layer of the powder 14 is preferably 50 mm or more, more preferably 60 mm or more, still more preferably 70 mm or more from the viewpoint of accelerating the adhesion of the powder 14 to the upper portion of the granular raw material 13 that has been dropped, and the thickness is preferably 250 mm or less, more preferably 230 mm or less, still more preferably 210 mm or less. In addition, when such an apparatus as illustrated in FIG. 2 to be described later is used, the thickness of the layer of the powder 14 is preferably 3 mm or more, more preferably 5 mm or more, still more preferably 8 mm or more from the viewpoint of accelerating the adhesion of the powder 14 to the upper portion of the granular raw material 13 that has been dropped. In addition, the thickness of the layer of the powder 14 is preferably 50 mm or less, more preferably 30 mm or less, still more preferably 20 mm or less, still more preferably 15 mm or less from the viewpoint of avoiding excessive use of the powder.

The temperature of the powder 14 is preferably 5° C. or more, more preferably 15° C. or more, still more preferably 20° C. or more from the viewpoint of further suppressing the occurrence of a dent in the solid particle 1 and from the viewpoint of retarding the solidification of the granular raw material 13 to accelerate the adhesion of the powder 14. In addition, the temperature of the powder 14 is preferably 60° C. or less, more preferably 55° C. or less, still more preferably 50° C. or less, still further more preferably 30° C. or less from the viewpoint of suppressing excessive adhesion of the powder 14 to the granular raw material 13. In particular, the temperature of the powder 14 is preferably 5° C. or more and 60° C. or less, more preferably 15° C. or more and 55° C. or less, still more preferably 20° C. or more and 50° C. or less, still further more preferably from 20° C. to 30° C. (normal temperature).

The time period for which the surface of the granular raw material 13 is coated with the powder 14 is preferably 2 seconds or more, more preferably 3 seconds or more, still more preferably 4 seconds or more from the viewpoint of accelerating the adhesion of the powder to the surface of the granular raw material 13. In addition, the time period for which the surface of the granular raw material 13 is coated with the powder 14 is preferably 24 hours or less, more preferably 12 hours or less, still more preferably 6 hours or less from the viewpoint of productivity.

When the powder 14 is stirred with a stirrer 16, the granular raw material 13 dropped into the powder 14 moves from the dropping position before the next granular raw material 13 is dropped, and hence the granular raw materials 13 can be prevented from adhering to each other.

The coating of the surface of the granular raw material 13 with the powder 14 may be performed under a state in which vibration is applied to the powder 14. For example, in FIG. 2, the use of the vibration feeder 23 in which the trough 21 is arranged on a vibration device 22 applies the vibration to the powder 14 on the trough 21. When the granular raw material 13 is dropped into the powder 14 having applied thereto the vibration, the surface of the granular raw material 13 can be coated with the powder 14 under a state in which the vibration is applied to the powder 14. At this time, it is preferred that the powder 14 be continuously supplied onto the trough 21 with the powder-supplying device (not shown).

The granular raw material 13 and the powder 14 are brought into contact with each other under a state in which the vibration is applied to the powder 14 to cause the powder 14 to adhere to the granular raw material 13, to thereby coat the surface of the granular raw material 13 with the powder 14. Thus, the powder 14 can be incorporated to a depth of at least about 80 μm from the surface of the granular raw material 13, and hence a solid particle excellent in adhesion resistance and transportation resistance is obtained.

In addition, a bowl may be used instead of the trough 21 as a container for storing the powder 14. Through use of a bowl feeder in which the bowl is arranged on the vibration device, the granular raw material that has been brought into contact with the powder having applied thereto the vibration ascends a slope arranged on the inner wall of the bowl through the vibration while the surface thereof is coated with the powder. To lengthen the time period for which the granular raw material and the powder are brought into contact with each other, when the trough 21 is used, the trough needs to be lengthened. However, when the bowl is used, space efficiency is satisfactory because an increase in number of spiral turns in the height direction thereof suffices for the purpose.

The amplitude of the vibration to be applied to the powder 14 at the time of the coating of the surface of the granular raw material 13 with the powder 14 is preferably 0.3 mm or more, more preferably 0.4 mm or more, still more preferably 0.5 mm or more, still more preferably 0.6 mm or more from the viewpoint of accelerating the adhesion of the powder 14 to the surface of the granular raw material 13. In addition, the amplitude of the vibration is preferably 5 mm or less, more preferably 4 mm or less, still more preferably 3 mm or less, still further more preferably 1.5 mm or less, still further more preferably 1.4 mm or less, still further more preferably 1.3 mm or less. In particular, the amplitude of the vibration is preferably 0.3 mm or more and 5 mm or less, more preferably 0.4 mm or more and 4 mm or less, still more preferably 0.5 mm or more and 4 mm or less, still more preferably 0.5 mm or more and 3 mm or less, still further more preferably 0.6 mm or more and 3 mm or less, still further more preferably 0.3 mm or more and 1.5 mm or less, still further more preferably 0.4 mm or more and 1.4 mm or less, still further more preferably 0.5 mm or more and 1.3 mm or less, still further more preferably 0.6 mm or more and 1.3 mm or less.

The amplitude of the vibration to be applied to the powder 14 is preferably measured at a position directly above the vibration device 22.

In addition, the frequency of the vibration is preferably 30 Hz or more, more preferably 40 Hz or more, still more preferably 50 Hz or more from the viewpoint of accelerating the adhesion of the powder 14 to the surface of the granular raw material 13. In addition, the frequency of the vibration is preferably 300 Hz or less, more preferably 100 Hz or less, still more preferably 75 Hz or less, still further more preferably 60 Hz or less. In particular, the frequency of the vibration is preferably 30 Hz or more and 300 Hz or less, more preferably 40 Hz or more and 100 Hz or less, still more preferably 50 Hz or more and 75 Hz or less, still further more preferably 50 Hz or more and 60 Hz or less.

The time period for which the surface of the granular raw material 13 is coated with the powder 14 in the apparatus illustrated in FIG. 2 is preferably 2 seconds or more, more preferably 3 seconds or more, still more preferably 4 seconds or more from the viewpoint of accelerating the adhesion of the powder to the surface of the granular raw material 13. In addition, the time period for which the surface of the granular raw material 13 is coated with the powder 14 is preferably 300 seconds or less, more preferably 200 seconds or less, still more preferably 100 seconds or less from the viewpoint of productivity. In particular, the time period for which the surface of the granular raw material 13 is coated with the powder 14 is preferably 2 seconds or more and 300 seconds or less, more preferably 3 seconds or more and 200 seconds or less, still more preferably 4 seconds or more and 100 seconds or less.

Through the above-mentioned coating of the surface of the granular raw material with the powder, the powder 14 is caused to adhere to the surface of the granular raw material 13, and the surface of the granular raw material 13 is coated with the powder 14. Thus, the solid particle 1 can be obtained.

### Second Aspect

An example of the second aspect of the production method for a solid particle according to at least one embodiment of the present invention is described below with reference to FIG. 1.

### [Impartment of Fluidity to Raw Material Composition]

The impartment of fluidity to the raw material composition is performed by heating the raw material composition containing the oily component. The raw material composition 10 having imparted thereto the fluidity may be obtained by heating the raw material composition to a temperature equal to or more than the melting point of at least one substance in the raw material composition. In addition, the heating preferably includes heating the raw material composition to its melting point or more.

A temperature for imparting the fluidity to the raw material composition is preferably 60° C. or more, more preferably 70° C. or more, still more preferably 80° C. or more, still more preferably 85° C. or more from the viewpoint of retarding the solidification of the granular raw material 13 to accelerate the adhesion of the powder 14 at the time of the coating of the surface of the granular raw material 13 with the powder 14. In addition, the temperature is preferably 150° C. or less, more preferably 130° C. or less, still more preferably 120° C. or less, still more preferably 115° C. or less from the viewpoint of preventing the deterioration of the raw material composition due to heat. In particular, the temperature for imparting the fluidity to the raw material composition is preferably 60° C. or more and 150° C. or less, more preferably 70° C. or more and 130° C. or less, still more preferably 80° C. or more and 120° C. or less, still more preferably 85° C. or more and 115° C. or less.

### [Formation of Granular Raw Material]

In the formation of the granular raw material, the raw material composition 10 having imparted thereto the fluidity is granulated through its ejection to form the granular raw material 13. When the raw material composition 10 having imparted thereto the fluidity illustrated in FIG. 1 is a liquid obtained by heating the raw material composition to its melting point or more, the ejection of the raw material composition 10 delivered by the pump 11 from the tip of the nozzle 12 can form the granular raw material 13 as a droplet. In addition, an apparatus for forming the granular raw material 13 from the raw material composition 10 having imparted thereto the fluidity is not limited to the apparatus illustrated in FIG. 1, and a known droplet-producing apparatus or the like may be used.

The granulation method is not limited to the case of ejection and dropping from the nozzle 12 as illustrated in FIG. 1, and can also be performed by methods involving, for example, changing the ejection direction from the nozzle, and cutting the flowed raw material composition 10 with a shutter or the like.

The solid particle 1 that is the object of the production method according to at least one embodiment of the present invention includes the core portion and the shell portion formed of the layer of the raw material composition that has incorporated therein the powder for coating the core portion, and hence the size thereof is substantially the same as or slightly larger than that of the granular raw material 13 formed as a droplet by being ejected from the tip of the nozzle 12. That is, the granular raw material 13 is preferably adjusted based on the average projected area, diameter, and/or weight of the solid particle 1 to be obtained when being placed on a plane.

The particle diameter of the granular raw material 13 mainly correlates with the outer diameter of the nozzle. When the outer diameter of the nozzle is increased, the particle diameter of the granular raw material 13 is increased. To this end, for example, when the granular raw material 13 is formed as a droplet by ejecting the raw material composition 10 that is a liquid from the tip of the nozzle 12, the outer diameter of the nozzle 12 may be changed in accordance with the particle diameter of the target solid particle. The outer diameter of the nozzle 12 is the same as that of the nozzle 12 described in the formation of the granular raw material in the above-mentioned first aspect.

[Coating of Surface of Granular Raw Material with Powder]

In the coating of the surface of the granular raw material with the powder, the granular raw material 13 is dropped into the powder 14 to coat the surface of the granular raw material 13 with the powder 14. The powder 14 may be stored in the container 15. In addition, when such an apparatus as illustrated in FIG. 2 to be described later is used, the powder 14, which falls to the sieve 24 through the operation of the vibration feeder 23, may be continuously supplied with a powder-supplying device in accordance with the falling speed so that the amount of the powder 14 on the trough 21 is constant.

The exposure ratio of the surface of the granular raw material 13 when being dropped into the powder 14 is 5% or less, that is, the granular raw material 13 is substantially buried in the powder 14, or the exposure ratio is 10% or more.

When the granular raw material 13 is substantially buried in the powder 14 at the time of the dropping of the granular raw material 13 into the powder 14, the exposure ratio of the granular raw material 13 is preferably 3% or less, more preferably 2% or less from the viewpoint of further suppressing the occurrence of a dent in the solid particle 1.

When the granular raw material 13 is exposed from the powder 14 at the time of the dropping of the granular raw material 13 into the powder 14, the exposure ratio of the granular raw material 13 is preferably 12% or more, more preferably 13% or more from the viewpoint of further suppressing the occurrence of a dent in the solid particle 1, and is preferably 35% or less, more preferably 30% or less from the viewpoint of ease of adhesion of the powder 14 to the granular raw material 13.

The exposure ratio of the granular raw material 13 is more preferably 2% or less, or 13% or more and 30% or less because the occurrence of a dent is suppressed and hence the solid particle 1 uniformly coated with the powder 14 is obtained.

The exposure ratio of the granular raw material 13 can be adjusted by the distance at which the granular raw material 13 is dropped, that is, the distance between the tip of the nozzle 12 and the outermost surface of the layer of the powder 14, and the size of the granular raw material 13.

The exposure ratio of the granular raw material 13 can be measured by a method described in Examples.

The distance at which the granular raw material 13 is dropped is preferably 5 mm or more, more preferably 10 mm or more, and preferably 25 mm or less, more preferably 20 mm or less from the viewpoints of adjusting the exposure ratio of the granular raw material 13 and suppressing the occurrence of a dent in the solid particle 1.

In addition, the distance at which the granular raw material 13 is dropped is preferably 35 mm or more, more preferably 40 mm or more from the viewpoints of substantially burying the granular raw material 13 in the powder 14 and suppressing the occurrence of a dent in the solid particle, and the distance is preferably 100 mm or less, more preferably 50 mm or less from the viewpoint of alleviating the impact at the time of contact between the granular raw material 13 that has been dropped and the powder 14 to prevent the deformation of the granular raw material 13.

The thickness of the layer of the powder 14 is preferably 50 mm or more, more preferably 60 mm or more, still more preferably 70 mm or more, and preferably 250 mm or less, more preferably 230 mm or less, still more preferably 210 mm or less from the viewpoint of suppressing the occurrence of a dent in the solid particle 1. In addition, when such an apparatus as illustrated in FIG. 2 to be described later is used, the thickness of the layer of the powder 14 is preferably 3 mm or more, more preferably 5 mm or more, still more preferably 8 mm or more from the viewpoint of accelerating the adhesion of the powder 14 to the upper portion of the granular raw material 13 that has been dropped, and the thickness is preferably 50 mm or less, more preferably 30 mm or less, still more preferably 20 mm or less, still more preferably 15 mm or less.

The temperature of the powder 14 is the same as the temperature of the powder 14 at the time of the coating of the surface of the granular raw material with the powder in the above-mentioned first aspect.

The time period for which the surface of the granular raw material 13 is coated with the powder 14 is the same as the time period for which the surface of the granular raw material 13 is coated with the powder 14 at the time of the coating of the surface of the granular raw material with the powder in the above-mentioned first aspect.

When the powder 14 is stirred with the stirrer 16, the granular raw material 13 dropped into the powder 14 moves from the dropping position before the next granular raw material 13 is dropped, and the granular raw materials 13 can be prevented from adhering to each other.

The coating of the granular raw material 13 with the powder 14 may be performed under a state in which vibration is applied to the powder 14. When the coating of the granular raw material 13 with the powder 14 is performed under a state in which vibration is applied to the powder 14, for example, the surface of the granular raw material 13 can be coated with the powder 14 in the same manner as in the above-mentioned first aspect with the apparatus illustrated in FIG. 2 of the first aspect. The preferred ranges and the like are also the same as those in the first aspect.

Through the above-mentioned coating of the surface of the granular raw material with the powder, the powder 14 is caused to adhere to the surface of the granular raw material 13, and the surface of the granular raw material 13 is coated with the powder 14. Thus, the solid particle 1 can be obtained.

### (Cooling)

In each of the first aspect and the second aspect, the granular raw material 13 may be additionally cooled simultaneously with the coating of the surface of the granular raw material 13 with the powder 14 and/or after the coating of the surface of the granular raw material with the powder. The performance of the cooling can further secure the adhesion of the powder 14 to the granular raw material 13. The cooling may be, for example, natural cooling or forced cooling, but natural cooling is preferred from the viewpoint of further suppressing the occurrence of a dent in the solid particle 1.

When the natural cooling is performed, the solid particle 1 in which the surface of the granular raw material 13 is coated with the powder 14 only needs to be left at rest under room temperature.

The granular raw material 13 softens at the time point when the surface of the granular raw material 13 is coated with the powder 14. The granular raw material 13 whose surface has been coated with the powder 14 is solidified at any subsequent stage. The term “solidification” means that cooling makes the hardness of the granular raw material 13 equal to the hardness of the raw material composition before the fluidity is imparted thereto.

A portion free of the powder 14 in which the granular raw material 13 is solidified is the core portion of the solid particle 1. The granular raw material 13 is formed by granulating the raw material composition, and is in a state before its solidification. In addition, a portion where the raw material composition incorporates the powder 14 in the inside of the granular raw material 13 near its surface is the shell portion of the solid particle 1.

After the coating of the surface of the granular raw material with the powder, the powder 14 that does not stick to the surface of the solid particle 1 may be removed prior to the cooling of the solid particle 1, after the cooling, or simultaneously with the cooling. The term “powder 14 that does not stick to the surface of the solid particle 1” refers to the powder 14, which adheres to the surface to such a weak extent as to fall from the solid particle 1 owing to an external force such as vibration to be applied at the time of, for example, the conveyance of the solid particle 1, or which does not adhere to any portion derived from the raw material composition at all.

A sieve having such an aperture as not to pass the solid particle 1 therethrough may be used in the removal of the powder.

### [Solid Particle]

The solid particle to be produced by the production method according to at least one embodiment of the present invention (hereinafter also referred to as “solid particle according to at least one embodiment of the present invention”) is a solid particle having a core-shell structure including a core portion formed of a granular solid raw material composition and a shell portion that coats at least part of the surface of the core portion. The shell portion is formed of a layer of the raw material composition having incorporated thereinto the powder. The powder may be a multilayer or a single layer, and a gap may be present between the particles for forming the powder.

In the solid particle according to at least one embodiment of the present invention, the strength of the inside of the solid particle near its surface is improved by the adhesion of the powder and its incorporation into the raw material composition. Accordingly, it may be possible to suppress, for example, the fracture, deformation, crushing, or collapse of the solid particle at the time of its transportation due to contact between the particles or between the particle and a container. Thus, the exposure of the core portion is suppressed, and hence adhesion between the solid particles can be suppressed. Accordingly, the solid particle may be excellent in transportation resistance. Further, a reduction in sense of use can be suppressed because the powder is present near the surface.

The term “solid particle” refers to a particle that is a solid at room temperature (25° C.), and has such a property as to soften or melt to obtain fluidity when heated to a temperature higher than room temperature, for example, 50° C. or more. To obtain such solid particle, as described later, for example, a raw material composition having a melting point of 50° C. or more only needs to be used.

### [Shape of Solid Particle]

Although the size of the solid particle is not particularly limited, the average projected area of the particles when the particles are mounted on a plane is preferably 0.5 mm² or more, more preferably 1 mm² or more, still more preferably 1.5 mm² or more from the viewpoints of, for example, ease of use such as the ease with which the particles are taken in a hand, the difficulty with which the particles roll, the ease with which the particles are crushed, a design property, and ease of production. In addition, the average projected area of the solid particles is preferably 320 mm² or less, more preferably 80 mm² or less, still more preferably 20 mm² or less in terms of, for example, ease of use such as the ease with which the particles are taken in a hand, the ease with which the particles are crushed, and a design property. In particular, the average projected area of the solid particles is preferably 0.5 mm² or more and 320 mm² or less, more preferably 1 mm² or more and 80 mm² or less, still more preferably 1.5 mm² or more and 20 mm² or less. The term “average projected area” means a number average determined as follows: 10 solid particles that have been randomly sampled are adopted as measurement objects; and under a state in which the solid particles are mounted in the most stable state on a horizontal plane, areas projected onto the horizontal plane with light from directly above are measured, and their number average is determined.

When the solid particle produced in the first aspect has a spherical shape or a substantially spherical shape, its diameter is preferably 0.5 mm or more, more preferably 1 mm or more, still more preferably 1.5 mm or more, and is preferably 20 mm or less, more preferably 15 mm or less, still more preferably 10 mm or less. The diameter of the solid particle having a spherical shape or a substantially spherical shape is preferably 0.5 mm or more and 20 mm or less, more preferably 1 mm or more and 15 mm or less, still more preferably 1.5 mm or more and 10 mm or less.

In addition, when the solid particle produced in the first aspect has a spheroidal shape or a substantially spheroidal shape, its diameter is a circle-equivalent diameter determined from the above-mentioned horizontal projection. The diameter is preferably 0.5 mm or more, more preferably 1 mm or more, still more preferably 1.5 mm or more, and is preferably 20 mm or less, more preferably 15 mm or less, still more preferably 10 mm or less. The diameter of the solid particle having a spheroidal shape or a substantially spheroidal shape is preferably 0.5 mm or more and 20 mm or less, more preferably 1 mm or more and 15 mm or less, still more preferably 1.5 mm or more and 10 mm or less.

Further, when the solid particle produced in the first aspect has a spheroidal shape or a substantially spheroidal shape, its height is a distance between a plane that is brought into contact with the solid particle, the plane being horizontal to the horizontal plane on which the solid particle is mounted, and being positioned at a place most distant therefrom, and the horizontal plane. The height is preferably 0.4 mm or more, more preferably 0.8 mm or more, still more preferably 1.2 mm or more, and is preferably 16 mm or less, more preferably 8 mm or less, still more preferably 4 mm or less. The height of the solid particle having a spheroidal shape or a substantially spheroidal shape is preferably 0.4 mm or more and 16 mm or less, more preferably 0.8 mm or more and 8 mm or less, still more preferably 1.2 mm or more and 4 mm or less.

When the solid particle produced in the second aspect has a spherical shape or a substantially spherical shape, its diameter is preferably 0.5 mm or more, more preferably 1 mm or more, still more preferably 1.5 mm or more, and is preferably 20 mm or less, more preferably 10 mm or less, still more preferably 5 mm or less. The diameter of the solid particle having a spherical shape or a substantially spherical shape is preferably 0.5 mm or more and 20 mm or less, more preferably 1 mm or more and 10 mm or less, still more preferably 1.5 mm or more and 5 mm or less.

In addition, when the solid particle produced in the second aspect has a spheroidal shape or a substantially spheroidal shape, its diameter is a circle-equivalent diameter determined from the above-mentioned horizontal projection. The diameter is preferably 0.5 mm or more, more preferably 1 mm or more, still more preferably 1.5 mm or more, and is preferably 20 mm or less, more preferably 10 mm or less, still more preferably 5 mm or less. The diameter of the solid particle having a spheroidal shape or a substantially spheroidal shape is preferably 0.5 mm or more and 20 mm or less, more preferably 1 mm or more and 10 mm or less, still more preferably 1.5 mm or more and 5 mm or less.

Further, when the solid particle produced in the second aspect has a spheroidal shape or a substantially spheroidal shape, its height is a distance between a plane that is brought into contact with the solid particle, the plane being horizontal to the horizontal plane on which the solid particle is mounted, and being positioned at a place most distant therefrom, and the horizontal plane. The height is preferably 0.4 mm or more, more preferably 0.8 mm or more, still more preferably 1.2 mm or more, and is preferably 16 mm or less, more preferably 8 mm or less, still more preferably 4 mm or less. The height of the solid particle having a spheroidal shape or a substantially spheroidal shape is preferably 0.4 mm or more and 16 mm or less, more preferably 0.8 mm or more and 8 mm or less, still more preferably 1.2 mm or more and 4 mm or less.

The average mass of the solid particles per particle is preferably 1 mg or more, more preferably 5 mg or more, still more preferably 10 mg or more. In addition, the average mass of the solid particles per particle is preferably 10,000 mg or less, more preferably 5,000 mg or less, still more preferably 1,000 mg or less. The average mass of the solid particles is preferably 1 mg or more and 10,000 mg or less, more preferably 5 mg or more and 5,000 mg or less, still more preferably 10 mg or more and 1,000 mg or less. The term “average mass” means the number average of the masses of 10 solid particles that have been randomly sampled.

The thickness of the shell portion of the solid particle, which depends on the properties of the powder and production conditions for the solid particle, is preferably 80 μm or more, more preferably 100 μm or more, still more preferably 110 μm or more, still further more preferably 120 μm or more, still further more preferably 130 μm or more, still further more preferably 150 μm or more from the viewpoint of improving the adhesion resistance and transportation resistance thereof. In particular, the thickness of the shell portion is preferably 110 μm or more because the adhesion resistance and transportation resistance of the solid particle are further improved. In addition, the thickness is preferably 300 μm or less, more preferably 250 μm or less, still more preferably 200 μm or less from the viewpoint of suppressing a reduction in sense of use of the sold particle.

The thickness of the shell portion includes thicknesses in the following cases: a case in which the powder having a diameter smaller than the above-mentioned thickness forms a multilayer; and a case in which the powder having a diameter equal to the above-mentioned thickness forms a single layer.

The content of the powder in the solid particle is preferably 5.0 mass % or more, more preferably 7.0 mass % or more, still more preferably 7.5 mass % or more, still further more preferably 8.0 mass % or more in terms of ratio with respect to the mass of the solid particle from the viewpoint of improving the adhesion resistance and transportation resistance of the solid particle. In addition, the content is preferably 30 mass % or less, more preferably 20 mass % or less, still more preferably 15 mass % or less, still further more preferably 13 mass % or less, still further more preferably 12 mass % or less from the viewpoint of eliminating an influence on the sense of use thereof.

The average strength of the solid particles per particle is preferably 0.14 N or more, more preferably 0.16 N or more from the viewpoint of the transportation resistance. In addition, the average strength of the solid particles per particle is preferably 3 N or less, more preferably 1 N or less from the viewpoint of the sense of use. The average strength of the solid particles is preferably 0.14 N or more and 3 N or less, more preferably 0.16 N or more and 1 N or less. The term “average strength” means the number average of the strengths of 10 solid particles that have been randomly sampled. The strength of the solid particle is measured by a method described in Examples.

### [Raw Material for Solid Particle]

### [Raw Material Composition]

The raw material composition is a solid at room temperature (25° C.), and has a melting point of preferably 50° C. or more, more preferably 55° C. or more, still more preferably 60° C. or more. When the raw material composition has a melting point equal to or more than those temperatures, the sense of use of the solid particle at the time of its use as a cosmetic can be improved because the granular raw material obtained by granulating the raw material composition serves as the core portion of the solid particle. In addition, the melting point of the raw material composition is preferably 150° C. or less, more preferably 120° C. or less, still more preferably 110° C. or less from the viewpoint of ease of production. Also when the raw material composition has a melting point equal to or less than those temperatures, the sense of use of the solid particle can be improved. In particular, the melting point of the raw material composition is preferably 50° C. or more and 150° C. or less, more preferably 55° C. or more and 120° C. or less, still more preferably 60° C. or more and 110° C. or less.

The raw material composition typically contains a plurality of substances. In this case, the melting point of the raw material composition is measured by any one of the first method, second method, and third method of the general test methods of the Japanese Standards of Quasi-drug Ingredients. Which one of the methods is adopted is selected mainly by the melting point of the raw material composition. When the melting point is as high as more than 75° C., the first method may be used, when the melting point is 50° C. or more and 75° C. or less, the second method may be used, and when the melting point is less than 50° C., the third method may be used.

The raw material composition is preferably a cosmetic raw material composition from the viewpoint that the solid particle according to at least one embodiment of the present invention is preferably used as a cosmetic.

The raw material composition preferably has a continuous phase formed of one or two or more kinds of oily components. In some cases, the raw material composition contains a powder component such as a pigment dispersed in the continuous phase.

Examples of the oily component include a hydrocarbon oil, an ester oil, an ether oil, a fatty acid, an alcohol, a silicone oil, and a fluorine oil. The number of carbon atoms in the oily component is preferably 6 or more, more preferably 10 or more, and is preferably 50 or less, more preferably 30 or less. Specific examples of the oily component include: waxes including: mineral waves, such as ozokerite and ceresin: petroleum waxes, such as a paraffin and a microcrystalline wax: synthetic hydrocarbons, such as a Fischer-Tropsch wax, a polyethylene wax, and a synthetic wax: plant waxes, such as a carnauba wax, a candelilla wax, a rice wax, a sunflower wax, a hydrogenated jojoba oil, and a Japanese wax: animal waxes, such as a beeswax and a whale wax; and synthetic waxes, such as a silicone wax, a synthetic beeswax, and a synthetic Japanese wax; oily gelling agents, such as dextrin palmitate, a sucrose fatty acid ester, inulin stearate, 12-hydroxystearic acid, dibutyl lauroyl glutamide, dibutyl ethylhexanoyl glutamide, and a polyamide resin; paste oils, such as vaseline, a vinyl leather wax, dipentaerythrityl hexa(behenate/benzoate/ethylhexanoathe), cholesteryl hydroxystearate, dipentaerythrityl tetra(hydroxystearate/isostearate), a hydrogenated palm oil, dipentaerythrityl hexahydroxystearate, glyceryl tri(caprylate/caprate/myristate/stearate), dipentaerythrityl hexa(hydroxystearate/stearate/rosinate), phytosteryl oleate, glyceryl (ethylhexanoate/stearate/adipate), di(octyldodecyl/phytosteryl/behenyl) lauroyl glutamate, (phytosteryl/isostearyl/cetyl/stearyl/behenyl) dimer dilinoleate, dimer dilinoleyl bis(behenyl/isostearyl/phytosteryl) dimer dilinoleate, hard lanolin, reduced lanolin, and bis-diglyceryl polyacyladipate-2: linear or branched hydrocarbon oils, such as a liquid paraffin, a light liquid isoparaffin, a heavy liquid isoparaffin, a mineral oil, squalane, an α-olefin oligomer, polyisobutylene, polybutene, hydrogenated polyisobutene, and hydrogenated polydecene; ester oils, such as isononyl isononanoate, isodecyl isononanoate, isotridecyl isononanoate, tricyclodecanemethyl isononanoate, ethyl isostearate, isobutyl isostearate, isopropyl isostearate, 2-hexyldecyl isostearate, di-2-ethylhexyl succinate, bis-ethoxydiglycol succinate, hexyl laurate, propanediol di(caprylate/caprate), neopentyl glycol diisononanoate, neopentyl glycol dicaprate, glyceryl diisostearate, polyglyceryl diisostearate, propanediol diisostearate, trimethylolpropane triisostearate, glyceryl triisostearate, diglyceryl triisostearate, diglyceryl tetraisostearate, diisostearyl malate, octyldodecyl malate, a glycerin fatty acid ester, a jojoba oil, di(phytosteryl/octyldodecyl) lauroyl glutamate, octyldodecyl myristate, isopropyl myristate, 2-ethylhexyl palmitate, isopropyl palmitate, cetyl 2-ethylhexanoate, trimethylolpropane tri-2-ethylhexanoate, glyceryl tri-2-ethylhexanoate, octyldodecyl myristate, 2-hexyldecyl myristate, 2-hexyldecyl 2-ethylhexanoate, neopentyl glycol di-2-ethylhexanoate, ethylhexyl hydroxystearate, glyceryl tri(caprylate/caprate), glyceryl trioctanoate, neopentyl glycol dioctanoate, tridecyl trimellitate, dipentaerythrityl tetraisostearate, pentaerythrityl tetraisostearate, octyl methoxy cinnamate, 2-ethylhexyl paramethoxycinnamate, diisopropyl dimerate, and propylene carbonate; higher alcohols, such as lauryl alcohol, oleyl alcohol, isostearyl alcohol, behenyl alcohol, and octyldodecanol; silicone oils, such as dimethylpolysiloxane, dimethylcyclopolysiloxane, methylphenylpolysiloxane, trimethylpentaphenyltrisiloxane, methylhydrogenpolysiloxane, higher alcohol-modified organopolysiloxane, and bisalkyl (C16-18) glycerin undecyl dimethicone; fluorine oils, such as a fluoropolyether, a perfluoroalkyl ether silicone, and a fluorine-modified silicone; and tocopherol, dipropylene glycol, and phenoxyethanol. Those oily components may be used alone or in combination thereof.

The raw material composition contains preferably 40 mass % or more, more preferably 50 mass % or more, still more preferably 60 mass % or more, still more preferably 70 mass % or more, still more preferably 75 mass % or more of the oily component in terms of the sense of use of the solid particle. From the same viewpoint, the raw material composition contains preferably 100 mass % or less, more preferably 99 mass % or less, still more preferably 98 mass % or less, still more preferably 97 mass % or less, still more preferably 95 mass % or less of the oily component. In particular, the raw material composition contains preferably 40 mass % or more and 100 mass % or less, more preferably 50 mass % or more and 99 mass % or less, still more preferably 60 mass % or more and 98 mass % or less, still more preferably 70 mass % or more and 97 mass % or less, still more preferably 75 mass % or more and 95 mass % or less of the oily component.

The raw material composition preferably contains an oily component that is in a solid state at 20° C. (has a melting point of more than 20° C.) (e.g., any one of the above-mentioned waxes) from the viewpoint of improving the shape-retaining property of the solid particle. The raw material composition contains preferably 5 mass % or more, more preferably 7 mass % or more of the oily component that is in a solid state at 20° C. from the viewpoint of the shape-retaining property of the solid particle. In addition, the raw material composition contains preferably 30 mass % or less, more preferably 12 mass % or less of the oily component that is in a solid state at 20° C. from the viewpoint of the sense of use of the solid particle. In particular, the raw material composition contains preferably 5 mass % or more and 30 mass % or less, more preferably 7 mass % or more and 12 mass % or less of the oily component that is in a solid state at 20° C. In addition, the raw material composition preferably contains an oily component that is in a liquid state at 20° C. (has a melting point of 20° C. or less) from the viewpoint of improving the sense of use of the solid particle. From this viewpoint, the raw material composition contains preferably 18 mass % or more, more preferably 25 mass % or more, still more preferably 35 mass % or more of the oily component that is in a liquid state at 20° C. From the same viewpoint, the raw material composition contains preferably 95 mass % or less, more preferably 93 mass % or less, still more preferably 90 mass % or less of the oily component that is in a liquid state at 20° C. In particular, the raw material composition contains preferably 18 mass % or more and 95 mass % or less, more preferably 25 mass % or more and 93 mass % or less, still more preferably 35 mass % or more and 90 mass % or less of the oily component that is in a liquid state at 20° C.

Whether or not the oily component is in a liquid state at 20° C. may be judged by contents described in the section “Physical State” of the safety data sheet (SDS) of each component. When the oily component that is in a liquid state at 20° C. is incorporated in the above-mentioned ranges into the raw material composition, the oily component is present on the surface of the core portion of the solid particle after its production, and the core portion is liable to be bonded to any other thing owing to the fact. In contrast, in the solid particle produced by the production method according to at least one embodiment of the present invention, the surface of the core portion is coated with the shell portion. Accordingly, unintended bonding between the solid particles or between the solid particle and any other thing is suppressed, and hence the solid particle has adhesion resistance.

For example, various components that have heretofore been used in cosmetics may each be used as the powder component in the raw material composition without any particular limitation. The powder component may be inorganic powder, or may be organic powder. The inorganic powder and the organic powder may be used in combination. The shape of a particle for forming the powder component is not particularly limited, and may be, for example, a spherical shape, a polyhedral shape, a flake shape, a spindle shape, a fibrous shape, an indefinite shape, or a combination thereof.

Pigments, such as a coloring pigment, a luster pigment, and an extender pigment, may each be used as the powder component in the raw material composition, and an inorganic powder pigment is preferred.

Examples of the coloring pigment include: metal oxides, such as titanium oxide, zinc oxide, yellow iron oxide, red iron oxide, black iron oxide, iron blue, ultramarine blue, chromium oxide, and chromium hydroxide: metal complexes, such as manganese violet and cobalt titanate: inorganic pigments such as carbon black: synthetic organic pigments, such as Red No. 3. Red No. 104, Red No. 106, Red No. 201, Red No. 202, Red No. 204, Red No. 205. Red No. 220, Red No. 226, Red No. 227. Red No. 228, Red No. 230, Red No. 401. Red No. 405, Red No. 505, Orange No. 203, Orange No. 204, Orange No. 205, Yellow No. 4, Yellow No. 5, Yellow No. 401, Blue No. 1, and Blue No. 404; and natural organic colors, such as β-carotene, caramel, and a paprika color.

Examples of the luster pigment include: a pigment obtained by coating the surface of sheet-shaped powder of mica, synthetic fluorophlogopite, glass, silica, alumina, or talc with a colorant including titanium oxide, iron oxide, silicon oxide, iron blue, chromium oxide, tin oxide, chromium hydroxide, gold, silver, carmine, or an organic pigment, such as Red No. 202 or Yellow No. 4; and a pigment obtained by cutting a raw material film of polyethylene terephthalate/polymethyl methacrylate laminated powder, polyethylene terephthalate/aluminum deposited powder, or polyethylene terephthalate/gold deposition-laminated powder into any appropriate shape.

Examples of the extender pigment include inorganic powders including silica, mica, synthetic fluorophlogopite, glass powder, barium sulfate, kaolin, bentonite, hectorite, zeolite, bismuth oxychloride, zirconium oxide, magnesium oxide, aluminum oxide, calcium sulfate, barium sulfate, magnesium sulfate, calcium carbonate, magnesium carbonate, and talc.

Further examples thereof include organic powders including nylon, polyethylene, a silicone elastomer such as a (vinyl dimethicone/methicone silsesquioxane) crosspolymer, polymethyl methacrylate, lauroyl lysine, silk powder, cellulose powder, a dispersant such as a polyvalent metal salt of a long-chain fatty acid, and various kinds of wax powder.

The ratio of the powder component in the raw material composition is preferably 0.01 mass % or more, more preferably 0.1 mass % or more, still more preferably 1 mass % or more, still more preferably 3 mass % or more, still more preferably 5 mass % or more. In addition, the ratio of the powder component in the raw material composition is preferably 60 mass % or less, more preferably 50 mass % or less, still more preferably 45 mass % or less, still more preferably 30 mass % or less, still more preferably 20 mass % or less. In particular, the ratio of the powder component in the raw material composition is preferably 0.01 mass % or more and 60 mass % or less, more preferably 0.1 mass % or more and 50 mass % or less, still more preferably 1 mass % or more and 45 mass % or less, still more preferably 3 mass % or more and 30 mass % or less, still more preferably 5 mass % or more and 20 mass % or less.

The hardness of the core portion is one factor that affects, for example, the sense of use of the solid particle. From this viewpoint, the hardness of the raw material composition is preferably 500 g or less, more preferably 350 g or less, still more preferably 250 g or less, still further more preferably 150 g or less. Meanwhile, unintended bonding between the raw material composition and any other thing can be suppressed by setting the hardness of the raw material composition to preferably 0.5 g or more, more preferably 5 g or more, still more preferably 15 g or more. From those viewpoints, the hardness of the raw material composition is preferably 0.5 g or more and 500 g or less, more preferably 5 g or more and 350 g or less, still more preferably 15 g or more and 250 g or less, still further more preferably 15 g or more and 150 g or less. The hardness of the raw material composition is measured by a method described in Examples.

### [Powder]

The ratio (powder adhesion ratio) of the powder to be used in the coating of the surface of the granular raw material with the powder to the mass of the solid particle is preferably 5 mass % or more, more preferably 7.0 mass % or more, still more preferably 7.5 mass % or more, still further more preferably 8.0 mass % or more from the viewpoints of the adhesion resistance and transportation resistance of the solid particle. In addition, the ratio is preferably 30 mass % or less, more preferably 20 mass % or less, still more preferably 15 mass % or less, still further more preferably 13 mass % or less, still further more preferably 12 mass % or less from the viewpoint of eliminating an influence on the sense of use thereof.

The same powder as that generally used in a cosmetic may be used as the powder without any particular limitation. The powder may be inorganic powder, and the inorganic powder may be a pigment. Alternatively, the powder may be organic powder. Although the inorganic powder and the organic powder may be used in combination, the inorganic powder is preferably incorporated and silica is more preferred.

Specifically, the same component as the powder component in the raw material composition described above may be used.

Powder having such a size that the adhesion of the solid particle serving as the object of the production method according to at least one embodiment of the present invention to any other thing in its production process is effectively prevented is suitably used as the powder. For example, when the sizes of particles for forming the powder are represented by a volume cumulative particle diameter D₅₀ at a cumulative volume of 50 vol % measured by a laser diffraction/scattering particle size distribution measurement method, the D₅₀ is preferably 0.01 μm or more, more preferably (0.1 μm or more, still more preferably 1 μm or more, still more preferably 5 μm or more, still more preferably 10 μm or more. The use of the powder having such size facilitates the performance of the operation of removing the powder. In addition, the D₅₀ is preferably 500 μm or less, more preferably 300 μm or less, still more preferably 160 μm or less, still more preferably 100 μm or less, still more preferably 30 μm or less. The use of the powder having such size can facilitate the adhesion of the powder to the surface of the granular raw material. In particular, the D₅₀ is preferably 0.01 μm or more and 500 μm or less, more preferably 0.1 μm or more and 300 μm or less, still more preferably 1 μm or more and 160 μm or less, still more preferably 5 μm or more and 100 μm or less, still more preferably 10 μm or more and 30 μm or less.

The oil absorption of the powder is preferably 5 mL/100 g or more, more preferably 15 mL/100 g or more, still more preferably 20 mL/100 g or more from the viewpoint of effectively preventing the adhesion of the solid particle to any other thing in its production process. In addition, the oil absorption of the powder is preferably 500 mL/100 g or less, more preferably 400 mL/100 g or less, still more preferably 350 mL/100 g or less from the viewpoint of preventing the powder from excessively absorbing the oily component in the granular raw material. The oil absorption is measured in conformity with JIS K 5101-13-1:2004.

The amount of the powder in the solid particle may be determined and measured by various methods. For example, when the powder is inorganic matter, its amount may be determined by burning organic matter in the solid particle and measuring its remaining ratio with a thermogravimetric differential thermal analyzer as described below. The amount of the powder that is inorganic matter is measured by a method described in Examples.

When the powder is organic matter, the amount of the powder adhering to the core portion may be determined as follows: a product obtained by dissolving all the components of the solid particle in a solvent is used as a sample; and the sample is subjected to measurement, such as ¹H-NMR or laser desorption/ionization mass spectrometry (LDI-MS).

The solid particle produced by the production method according to at least one embodiment of the present invention is preferably used as a cosmetic. The solid particle may be used in, for example, a makeup method including crushing the particle and applying the crushed particle to a human body for cosmetic purposes. Specifically, the following may be performed: the solid particle is mounted on a cosmetic palette, and is crushed with a makeup brush, followed by its application to a lip with the makeup brush like a lipstick. Alternatively, the following may be performed: the solid particle is crushed on the back of a hand, and is applied to a cheek with a finger like a blusher or a concealer. Alternatively, the following may be performed: the solid particle is crushed on the back of a hand, and is applied to a finger or the back of the hand with the finger like a hand cream. Further, the solid particle may be used like an oil cleansing by being crushed with a hand. Further, the solid particle may be used like a treatment or a hair wax by being crushed with a hand or a tool and applied to hair.

The present invention has been described above on the basis of its exemplary embodiments. However, the present invention is not limited to the embodiments.

According to the production method of at least one embodiment of present invention, the solid particle having the occurrence of a dent suppressed can be provided.

### EXAMPLES

The present invention is described in more detail below by way of Examples. However, the scope of the present invention is not limited to these Examples.

### [Preparation of Raw Material Composition]

The composition of a raw material composition for a lipstick is shown in Table 1 below, and the composition of a raw material composition for an eye shadow is shown in Table 2 below. In each of the raw material compositions, base raw materials were heated and dissolved at 110° C. for 30 minutes, and were uniformly mixed with a disper. Next, a coloring pigment, a luster pigment, and an extender pigment, or the coloring pigment, the luster pigment, and a dispersant were added to the base raw materials, and the materials were further uniformly mixed for 15 minutes, followed by degassing. After that, the mixture was naturally cooled to be solidified. Thus, the raw material compositions were prepared. The melting points of the prepared raw material compositions were measured in accordance with the general test methods of the Japanese Standards of Quasi-drug Ingredients. As a result, the raw material composition for a lipstick had a melting point of 68.1° C., and the raw material composition for an eye shadow had a melting point of 82.2° C.

The raw material composition for a lipstick prepared in the foregoing was heated and dissolved at 115° C., and was filled into a resin-made ointment jar (having a diameter of 30 mm and a height of 14 mm) up to a height of 10 mm. After that, the composition was cooled at 20° C. for 2 hours to be solidified, and was left at rest at 30° C. for 6 hours or more. After that, the hardness of the raw material composition for a lipstick was measured with a rheometer manufactured by Rheotech by reading the maximum of a load when a jig having a diameter of 2 mm was caused to penetrate into the composition to a depth of 2 mm at a table speed of 2 mm/s. As a result, the hardness was 35 g.

The hardness of the raw material composition for an eye shadow prepared in the foregoing was measured under the same conditions. As a result, the hardness was 41 g.

TABLE 1

| | | Ratio |
|---|---|---|
| | | (mass %) |
| Base | Paraffin | 4.0 |
| | Polyethylene wax | 2.0 |
| | Microcrystalline wax | 2.0 |
| | (Multi-branched isostearic acid) | 30.0 |
| | dipentaerythrityl tetraisostearate | |
| | Hydrogenated polyisobutene | 10.0 |
| | Di(phytosteryl/octyldodecyl) lauroyl glutamate | 10.0 |
| | Octyldodecanol | 15.0 |
| | Bisalkyl (C16-18) glycerin undecyl dimethicone | 6.0 |
| | Glyceryl tri(caprylate/caprate) | 10.2 |
| | Tocopherol | 0.1 |
| | Dipropylene glycol | 0.1 |
| Coloring | Red No. 202 | 0.3 |
| pigment | Yellow No. 4 Aluminum Lake | 0.2 |
| | Yellow iron oxide | 0.5 |
| | Red iron oxide | 0.1 |
| | Titanium oxide | 1.0 |
| Luster | Mica titanium | 2.0 |
| pigment | Titanium oxide-coated glass flake | 1.5 |
| Extender | Mica | 5.0 |
| pigment | | |

| | |
|---|---|
| Total | 100.0 |

TABLE 2

| | | Ratio |
|---|---|---|
| | | (mass %) |
| Base | Paraffin | 4.0 |
| | Synthetic wax | 3.0 |
| | Microcrystalline wax | 2.0 |
| | (Multi-branched isostearic acid) | 25.0 |
| | dipentaerythrityl tetraisostearate | |
| | Polyglyceryl-2 triisostearate | 5.0 |
| | Polyglyceryl-2 diisostearate | 5.0 |
| | Isotridecyl isononanoate | 15.0 |
| | Glyceryl tri(caprylate/caprate) | 20.45 |
| Coloring | Red No. 202 | 0.05 |
| pigment | | |
| Luster | Titanium oxide-coated glass flake | 20.0 |
| pigment | | |
| Dispersant | Zinc stearate | 0.5 |

| | |
|---|---|
| Total | 100.0 |

As shown in Table 1, the amount of oily components in the raw material composition was the amount of components shown as bases, that is. 89.4 mass %, and the amount of powder components therein was the total amount of the coloring pigments, the luster pigments, and the extender pigment, that is, 10.6 mass %. In addition, the amount of oily components each of which had a melting point of more than 20° C. (was a solid at 20° C.) in the raw material composition was the total amount of the paraffin, the polyethylene wax, and the microcrystalline wax, that is, 8 mass %, and the amount of oily components each of which had a melting point of 20° C. or less (was a liquid at 20° C. or less) therein was the total amount of the other components, that is, 81.4 mass %.

As shown in Table 2, the amount of oily components in the raw material composition for an eye shadow was the amount of components shown as bases, that is, 79.45 mass %, and the amount of powder components therein was the total amount of the coloring pigment, the luster pigment, and the dispersant, that is, 20.55 mass %. In addition, the amount of oily components each of which had a melting point of more than 20° C. (was a solid at 20° C.) in the raw material composition for an eye shadow was the total amount of the paraffin, the synthetic wax, and the microcrystalline wax, that is, 9.0 mass %, and the amount of oily components each of which had a melting point of 20° C. or less (was a liquid at 20° C. or less) therein was the total amount of the other components, that is, 70.45 mass %.

### Example 1-1

### Production of Granular Raw Material

The plurality of granular raw materials 13 were formed from the raw material composition for a lipstick with the apparatus illustrated in FIG. 2. That is, the raw material composition for a lipstick having imparted thereto fluidity through the melting of the raw material composition 10 by heating to 90° C. was delivered with the pump 11 at 5.2 mL/min, and was ejected from the tip of the nozzle 12 having an inner diameter of 2.0 mm and an outer diameter of 3.2 mm at a temperature of the raw material composition and a dropping distance shown in Table 3. Thus, the granular raw materials 13 serving as droplets were formed. The term “dropping distance” refers to a distance between the tip of the nozzle 12 and the outermost surface of the layer of the powder 14. The temperature of the raw material composition refers to the temperature of the nozzle 12, and a measurement method thereof is described below.

### (Measurement of Temperature of Raw Material Composition)

The temperature of the raw material composition in the formation of the granular raw material 13 was determined by measuring the temperature of the tip of the nozzle with an infrared camera (manufactured by FLIR Systems, smartphone-connected thermography FLIR ONE PRO) when the raw material composition for a lipstick was ejected from the nozzle 12 to be granulated.

Dropping of Granular Raw Material into Powder and Coating thereof with Powder

The granular raw materials 13 formed in the foregoing were dropped at a dropping distance of 76 mm onto the trough 21 to which the powder 14 at a temperature of 25° C. having applied thereto vibration having an amplitude of 0.663 mm and a frequency of 54.0 Hz by the vibration feeder 23 (SMALL ELECTROMAGNETIC FEEDER CF-2 manufactured by Sinfonia Technology Co., Ltd.) including the vibration device 22 and the trough 21 was supplied and mounted so as to have a thickness of 10 mm. The powder 14 was caused to adhere to the surface of each of the granular raw materials 13 by bringing the granular raw materials 13 and the powder 14 into contact with each other.

Spherical silica having an average particle diameter D₅₀ of 15 μm and an oil absorption of 150 mL/100 g was used as the powder 14. Thus, the target solid particles 1 for a lipstick in each of which the granular raw material 13 was coated with the powder 14 by the adhesion of the powder 14 to the surface of the granular raw material 13 were obtained.

The value of the amplitude is a value obtained by measuring an amplitude directly above the vibration device 22 on the upper surface of the trough 21 with a laser displacement meter (LK-G 5000 manufactured by Keyence Corporation). The measurement was performed under the following conditions: the measurement was performed in a diffusion-reflection mode at a sampling period of 200 μs (5 kHz) and a moving average of 4.

### (Powder Removal and Cooling)

After that, the powder 14 and the solid particles 1 were separated from each other with the sieve 24 having an aperture of 2.000 μm under room temperature (25° C.) so that the powder 14 that did not adhere to the solid particles 1 was removed. The solid particles 1 were naturally cooled on the sieve 24 for 1 minute or more, and were recovered.

### [Evaluation of Solid Particles 1]

Ten particles were randomly sampled from the resultant solid particles 1, and were evaluated. As a result, the ten particles had an average mass of 23.8 mg, an average diameter of 4.0 mm, an average height of 3.0 mm, an average powder adhesion ratio of 5.0 mass %, and a dent occurrence ratio of 18.2 number %. The average powder adhesion ratio and the dent occurrence ratio were determined by methods described below.

### <Evaluation of Particle Shape>

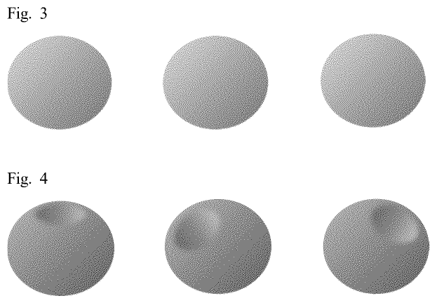

150 Particles were randomly sampled from the resultant solid particles 1 and visually determined for the presence or absence of dents on surfaces. From all the sampled solid particles 1, solid particles 1-1 having no dents on surfaces illustrated in FIG. 3 and solid particles 1-2 having dents on surfaces illustrated in FIG. 4 were selected, and the occurrence ratio of solid particles having dents (hereinafter sometimes referred to as “dent occurrence ratio”) was calculated by the following equation.

Dent occurrence ratio(number %)−solid particles 1−2(number)/solid particles 1−1(number)×100

### <Powder Adhesion Ratio>

The amount (adhesion ratio) of the silica used as the powder 14 in the solid particles 1 was determined as described below.

Ten particles were randomly sampled from the resultant solid particles 1, and the temperature of each of the ten particles was increased from 25° C. to 600° C., at 10° C./min with a thermogravimetric differential thermal analyzer “TG-DTA EXSTAR 6200” manufactured by Hitachi High-Tech Science Corporation while air was supplied at 200 mL/min, followed by the measurement of the mass of the residue after the burning. A value calculated from the following equation by using the mass of the residue when only a raw material composition having the same mass as that of the raw material composition used in the production of the solid particles 1 was subjected to the same treatment was defined as a powder adhesion ratio. An average of the powder adhesion ratios of the ten solid particles 1 is defined as an average powder adhesion ratio.

$$( Powder adhesion ratio ( mass \% ) ) =$$

$$( mass \% of residue of solid particles 1 ) -$$

$$[ ( mass \% of residue of raw material composition ) / [ 100 -$$

$$1 ) - ( mass \% of residue of raw material composition ) ] ] \times$$

$$[ 100 - ( mass \% of residue of solid particles 1 ) ]$$

### Example 1-2

The solid particles 1 for a lipstick were produced in the same manner as in Example 1-1 except that the temperature of the raw material composition for the production method was changed as shown in Table 3 by measuring the temperature of the tip of the nozzle 12 when the raw material composition was ejected to be granulated in the same manner as in Example 1-1 and controlling the temperature of the nozzle 12. The results obtained by evaluating the resultant solid particles 1 in the same manner as in Example 1-1 are shown in Table 3.

### Examples 1-3 to 1-6

The solid particles 1 for eye shadows were each produced in the same manner as in Example 1-1 except that the raw material composition was changed to the raw material composition for an eye shadow, and the temperature of the raw material composition for the production method was changed as shown in Table 3 by measuring the temperature of the nozzle 12 when the raw material composition was ejected to be granulated in the same manner as in Example 1-1 and controlling the temperature of the nozzle 12. The results obtained by evaluating the resultant solid particles 1 in the same manner as in Example 1-1 are shown in Table 3.

### Comparative Example 1-1

The solid particles 1 for a lipstick were produced in the same manner as in Example 1-1 except that the temperature of the raw material composition for the production method was changed as shown in Table 3 by measuring the temperature of the tip of the nozzle 12 when the raw material composition was ejected to be granulated in the same manner as in Example 1-1 and controlling the temperature of the nozzle 12. The results obtained by evaluating the resultant solid particles 1 in the same manner as in Example 1-1 are shown in Table 3.

TABLE 3

| | | | | | | | | | Comparative |
|---|---|---|---|---|---|---|---|---|---|
| | | | Example | | | | | | Example |
| | | | 1-1 | 1-2 | 1-3 | 1-4 | 1-5 | 1-6 | 1-1 |
| Granular raw | Raw material composition | | Lipstick | Lipstick | Eye | Eye | Eye | Eye | Lipstick |
| material | | | | | shadow | shadow | shadow | shadow | |
| | Melting point | [° C.] | 68.1 | 68.1 | 82.2 | 82.2 | 82.2 | 82.2 | 68.1 |
| Powder | Kind | | Silica | Silica | Silica | Silica | Silica | Silica | Silica |
| | Average particle | [μm] | 15 | 15 | 15 | 15 | 15 | 15 | 15 |
| | diameter | | | | | | | | |
| Production | Temperature of raw | [° C.] | 76.0 | 81.0 | 86.3 | 84.2 | 88.1 | 89.4 | 87.0 |
| condition | material composition | | | | | | | | |
| | Dropping flow rate | [mL/min] | 5.2 | 5.2 | 4.0 | 4.0 | 4.0 | 4.0 | 5.2 |
| | Dropping distance | [mm] | 6 | 6 | 15 | 15 | 15 | 15 | 6 |
| | ΔT *1 | [° C.] | 7.9 | 12.9 | 4.1 | 2.0 | 5.9 | 7.2 | 18.9 |
| Evaluation of | Average mass | [mg] | 23.8 | 21.8 | 22.3 | 22.9 | 22.8 | 23.0 | 20.8 |
| solid particle | Average diameter | [mm] | 4.0 | 4.0 | 4.6 | 4.6 | 4.5 | 4.5 | 3.9 |
| | Average height | [mm] | 3.0 | 2.8 | 2.8 | 3.2 | 3.1 | 3.0 | 2.8 |
| | Average powder | [mass %] | 5.0 | 5.9 | 6.8 | 6.1 | 7.8 | 8.4 | 7.4 |
| | adhesion ratio | | | | | | | | |
| | Dent occurrence | [number %] | 18.2 | 67.5 | 0.0 | 7.3 | 5.5 | 12.3 | 90.1 |
| | ratio | | | | | | | | |

*1: means a difference between the temperature of the raw material composition and the melting point of the raw material composition.

As shown in Table 3, it is understood from Examples and Comparative Example that the occurrence ratio of solid particles having dents in production of solid particles is decreased by reducing a temperature difference (ΔT) between the temperature of the raw material composition in the formation of the granular raw material and the melting point of the raw material composition.

Thus, according to the production method of at least one embodiment of the present invention, the occurrence of a dent in a solid particle is suppressed, and hence a solid particle having satisfactory appearance can be obtained in a high yield.

### Example 2-1

### Production of Granular Raw Material

The plurality of granular raw materials 13 were formed from the raw material composition for an eye shadow with the apparatus illustrated in FIG. 2. That is, the raw material composition 10 for an eye shadow having imparted thereto fluidity through the melting of the raw material composition 10 by heating to 90° C. was delivered at 4.0 mL/min with the pump 11, and was ejected at a dropping distance shown in Table 4 from the tip of the nozzle 12 having an inner diameter of 2.0 mm and an outer diameter of 3.2 mm. Thus, the granular raw materials 13 serving as droplets were formed. The dropping distance refers to a distance between the tip of the nozzle 12 and the outermost surface of the layer of the powder 14, and the temperature of the raw material composition 10 at the time of the ejection from the nozzle 12 was 86° C.

Dropping of Granular Raw Material into Powder and Coating thereof with Powder

The granular raw materials 13 formed in the foregoing were dropped into the powder 14 on the trough 21 to which the powder 14 at a temperature of 25° C. having applied thereto vibration having an amplitude of 0.663 mm and a frequency of 54.0 Hz by the vibration feeder 23 (SMALL ELECTROMAGNETIC FEEDER CF-2 manufactured by Sinfonia Technology Co., Ltd.) including the vibration device 22 and the trough 21 was supplied and mounted so as to have a thickness of 10 mm. The powder 14 was caused to adhere to the surface of each of the granular raw materials 13 by bringing the granular raw materials 13 and the powder 14 into contact with each other. The exposure ratio of the granular raw materials 13 when being dropped into the powder 14 was 27.5 area %.

Spherical silica having an average particle diameter D₅₀ of 15 μm and an oil absorption of 150 mL/100 g was used as the powder 14. Thus, the target solid particles 1 for a lipstick in each of which the granular raw material 13 was coated with the powder 14 by the adhesion of the powder 14 to the surface of the granular raw material 13 were obtained.

The value of the amplitude is a value obtained by measuring an amplitude directly above the vibration device 22 on the upper surface of the trough 21 with a laser displacement meter (LK-G 5000 manufactured by Keyence Corporation). The measurement was performed under the following conditions: the measurement was performed in a diffusion-reflection mode at a sampling period of 200 μs (5 kHz) and a moving average of 4.

### (Measurement of Exposure Ratio)

The process in which the granular raw material 13 was dropped into the powder 14 in the coating of the surface of the granular raw material with the powder was photographed with a high-speed camera (manufactured by Kron Technologies Inc., Chronos 1.4, frame rate: 500 fps), and a moving image was cut out as a still image. The size of the granular raw material 13 was measured by binarizing the still image and subjecting the binarized image to image analysis. The number of pixels of the diameter of the granular raw material 13 and that of the radius of a bottom surface of a spherical segment of an exposed portion of the granular raw material 13 immediately after dropping were each sampled based on a scale arranged in a screen, and converted into millimeter. Thus, an average value “r” (mm) of a radius of the granular raw material 13 at the time of dropping and an average value “d” (mm) of a radius of the bottom surface of the spherical segment of the exposed portion of the granular raw material 13 immediately after dropping were measured. An average value S₁ (=4πr²) (mm²) of the surface area of the granular raw material 13 was calculated from the value of “r”. When the height of the exposed portion (spherical segment) immediately after the granular raw material 13 is dropped into the powder 14 is represented by “h” (mm), h=r−√(r²−d²) is established. When the surface area of the exposed portion (spherical cap) is represented by S₂ (mm²), S₂=2πrh=2πr(r−√(r²−d²)) is established. Based on the above-mentioned calculations, the exposure ratio of the granular raw material 13 was obtained by the following equation.

$$Exposure ratio ( area \% ) = {S}_{2} / {S}_{1} \times 100$$

Here, the “immediately after dropping” of the granular raw material 13 refers to a point of time at which the flying powder 14 settles down after the granular raw material 13 is dropped into the powder 14. In all Examples and Comparative Example, this point of time was 0.033 second after a point of time at which the granular raw material 13 was brought into contact with the surface of the powder 14.

### (Powder Removal and Cooling)

After that, the powder 14 and the solid particles 1 were separated from each other with the sieve 24 having an aperture of 2,000 μm under room temperature (25° C.) so that the powder 14 that did not adhere to the solid particles 1 was removed. The solid particles 1 for an eye shadow were naturally cooled on the sieve 24 for 1 minute or more, and were recovered.

### [Evaluation of Solid Particles 1]

Ten particles were randomly sampled from the resultant solid particles 1, and were evaluated. As a result, the ten particles had an average mass of 22.5 mg, an average diameter of 4.2 mm, an average height of 2.7 mm, an average powder adhesion ratio of 6.8 mass %, and a dent occurrence ratio of 6.1 number %. The average powder adhesion ratio and the dent occurrence ratio were determined by the methods described in Example 1-1.

### Examples 2-2 to 2-4 and Comparative Example 2-1

The solid particles 1 were each produced in the same manner as in Example 2-1 except that the dropping distance was changed as shown in Table 4. Results obtained by evaluating the resultant solid particles 1 in the same manner as in Example 2-1 are shown in Table 4.

TABLE 4

| | | | | | | | Comparative |
|---|---|---|---|---|---|---|---|
| | | | Example | | | | Example |
| | | | 2-1 | 2-2 | 2-3 | 2-4 | 2-1 |
| Production | Dropping distance | [mm] | 10 | 20 | 25 | 40 | 30 |
| condition | | | | | | | |
| Measurement | Radius “r” of solid particle | [mm] | 2.1 | 2.1 | 2.0 | 2.1 | 2.1 |
| value of | Surface area “S₁” of solid | [mm²] | 55.2 | 56.1 | 52.2 | 54.5 | 57.4 |
| granular raw | particle | | | | | | |
| material | Radius “d” of bottom surface | [mm] | 1.9 | 1.5 | 1.4 | 0.4 | 1.1 |
| | of exposed portion | | | | | | |
| | Height “h” of exposed | [mm] | 1.15 | 0.64 | 0.53 | 0.04 | 0.30 |
| | spherical segment | | | | | | |
| | Surface area “S₂” of exposed | [mm²] | 15.2 | 8.5 | 6.8 | 0.6 | 4.0 |
| | spherical cap | | | | | | |
| | Exposure ratio | [area %] | 27.5 | 15.2 | 13.1 | 1.0 | 6.9 |
| Evaluation of | Average mass | [mg] | 22.5 | 22.2 | 22.6 | 22.5 | 22.6 |
| solid particle | Average diameter | [mm] | 4.2 | 4.2 | 4.1 | 4.2 | 4.3 |
| | Average height | [mm] | 2.7 | 2.6 | 2.8 | 3.0 | 3.1 |
| | Average powder adhesion ratio | [mass %] | 5.8 | 6.7 | 6.9 | 7.8 | 7.7 |
| | Dent occurrence ratio | [number %] | 6.1 | 5.4 | 8.6 | 0.0 | 50.0 |

As shown in Table 4, it is understood from Examples and Comparative Example that the occurrence ratio of solid particles having dents in production of solid particles is decreased by setting the exposure ratio of the granular raw material when being dropped into the powder within a specific range.

Thus, according to the production method of at least one embodiment of the present invention, the occurrence of a dent in a solid particle is suppressed, and hence a solid particle having satisfactory appearance can be obtained in a high yield.

### REFERENCE SIGNS LIST

1 solid particle
10 raw material composition having imparted thereto fluidity
11 pump
12 nozzle
13 granular raw material
14 powder
15 container
16 stirrer
21 trough
22 vibration device
23 vibration feeder
24 sieve

1. A production method for a solid particle, comprising:
heating a raw material composition containing an oily component to impart fluidity to the raw material composition;
granulating the raw material composition having imparted thereto the fluidity to form a granular raw material; and
dropping the granular raw material into powder to coat a surface of the granular raw material with the powder,
wherein a temperature of the raw material composition at a time of ejection in formation of the granular raw material is equal to or more than a melting point of the raw material composition and is equal to or less than a temperature higher by 17° C. than the melting point.

2. The production method for a solid particle according to claim 1, wherein the powder contains silica.

3. The production method for a solid particle according to claim 1, further comprising cooling the granular raw material.

4. The production method for a solid particle according to claim 1, further comprising removing the powder that is free from adhering to the solid particle.

5. The production method for a solid particle according to claim 1, wherein the powder has an average particle diameter D₅₀ of 0.01 μm or more and 500 μm or less.

6. The production method for a solid particle according to claim 1, wherein the solid particles to be obtained have an average mass per particle of 1 mg or more and 10,000 mg or less.

7. The production method for a solid particle according to claim 1, wherein the coating of the surface of the granular raw material with the powder is performed under a state in which vibration is applied to the powder.

8. The production method for a solid particle according to claim 7, wherein the vibration has an amplitude of 0.3 mm or more and a frequency of 30 Hz or more.

9. A production method for a solid particle, comprising:
heating a raw material composition containing an oily component to impart fluidity to the raw material composition;
granulating the raw material composition having imparted thereto the fluidity to form a granular raw material; and
dropping the granular raw material into powder to coat a surface of the granular raw material with the powder,
wherein an exposure ratio of the granular raw material when being dropped into the powder is one of 5% or less or 10% or more.

10. The production method for a solid particle according to claim 9, wherein the powder contains silica.

11. The production method for a solid particle according to claim 9, further comprising cooling the granular raw material.

12. The production method for a solid particle according to claim 9, further comprising removing the powder that is free from adhering to the solid particle.

13. The production method for a solid particle according to claim 9, wherein the heating comprises heating the raw material composition to a melting point thereof or more.

14. The production method for a solid particle according to claim 9, wherein the powder has an average particle diameter D₅₀ of 0.01 μm or more and 500 μm or less.

15. The production method for a solid particle according to claim 9, wherein the solid particles to be obtained have an average mass per particle of 1 mg or more and 10,000 mg or less.

16. The production method for a solid particle according to claim 9, wherein the coating of the surface of the granular raw material with the powder is performed under a state in which vibration is applied to the powder.

17. The production method for a solid particle according to claim 16, wherein the vibration has an amplitude of 0.3 mm or more and a frequency of 30 Hz or more.
